(19) United States
(12) Patent Application Publication
(10) Pub. No.: US 2025/0033379 A1
(43) Pub. Date: Jan. 30, 2025

(54) PRINTING APPARATUS AND COMPUTER-READABLE STORAGE MEDIUM

(71) Applicant: CANON KABUSHIKI KAISHA, Tokyo (JP)

(72) Inventor: MASAHIRO YAMAMOTO, Tokyo (JP)

(21) Appl. No.: 18/780,851

(22) Filed: Jul. 23, 2024

(30) Foreign Application Priority Data
Jul. 24, 2023 (JP) 2023-120182

(51) Int. Cl. B41J 11/00; B41J 13/00; B41J 13/03; B41J 13/10

(52) U.S. Cl. CPC B41J 11/003; B41J 11/0095; B41J 13/0054; B41J 13/0072; B41J 13/03; B41J 13/103; B41J 13/106

(57) ABSTRACT

A printing apparatus capable of performing printing on a plurality of kinds of sheets, comprising a print unit configured to perform printing on a sheet, a feed unit configured to feed a sheet toward the print unit, and a control unit configured to, in a case of successively performing printing on a plurality of sheets by the print unit, control the feed unit to perform overlapped feeding in which a succeeding sheet is fed such that a trailing end portion of a preceding sheet and a leading end portion of the succeeding sheet overlap, wherein, in a case of executing the overlapped feeding, the control unit makes a predetermined notification based on a comparison result of a length of the succeeding sheet with a threshold value corresponding to a sheet kind of the succeeding sheet.

### BACKGROUND OF THE INVENTION

### Field of the Invention

The present invention mainly relates to a printing apparatus.

### Description of the Related Art

Some of the printing apparatuses such as inkjet printers are configured to consecutively feed two or more sheets serving as print media, sequentially perform printing on the sheets, and convey the sheets in an overlapping state during execution of the printing (Japanese Patent Laid-Open Nos. 2000-15881 and 2001-301282). Such conveyance control is also expressed as overlapped feeding. This conveyance mode can improve the efficiency of printing processing.

Some of the printing apparatuses are configured to be capable of handling various sheet kinds and advantageous in improving usability. On the other hand, in the above-described printing apparatus capable of executing overlapped feeding, depending on the sheet kind, it may be difficult to realize proper overlapped feeding because the degree of bending/warpage of a sheet inside the apparatus changes.

### SUMMARY OF THE INVENTION

The present invention provides a technique advantageous in further improvement of usability.

One of the aspects of the present invention provides a printing apparatus capable of performing printing on a plurality of kinds of sheets, comprising a print unit configured to perform printing on a sheet, a feed unit configured to feed a sheet toward the print unit, and a control unit configured to, in a case of successively performing printing on a plurality of sheets by the print unit, control the feed unit to perform overlapped feeding in which a succeeding sheet is fed such that a trailing end portion of a preceding sheet and a leading end portion of the succeeding sheet overlap, wherein, in a case of executing the overlapped feeding, the control unit makes a predetermined notification based on a comparison result of a length of the succeeding sheet with a threshold value corresponding to a sheet kind of the succeeding sheet.

Further features of the present invention will become apparent from the following description of exemplary embodiments (with reference to the attached drawings).

### BRIEF DESCRIPTION OF THE DRAWINGS

FIG. 1 is a perspective view showing an example of the outer appearance of a printing apparatus;

FIG. 2 is a block diagram showing an example of the system configuration of the printing apparatus;

FIG. 3 is a schematic sectional view of the printing apparatus;

FIGS. 4A and 4B are a flowchart illustrating a printing operation accompanying overlapped feeding;

FIGS. 5A and 5B are schematic views for explaining an example of the conveyance mode of a succeeding sheet;

FIG. 6 is a flowchart illustrating a recovery operation performed after a succeeding sheet shift occurs;

FIG. 7 is a flowchart for performing a printing operation not accompanying overlapped feeding;

FIG. 8 is a view showing an example of a setting screen regarding overlapped feeding;

FIGS. 9A and 9B are views each showing an example of a notification screen displayed after a succeeding sheet shift occurs; and

FIGS. 10A and 10B are views showing examples of threshold values for determining a succeeding sheet shift.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### EMBODIMENTS

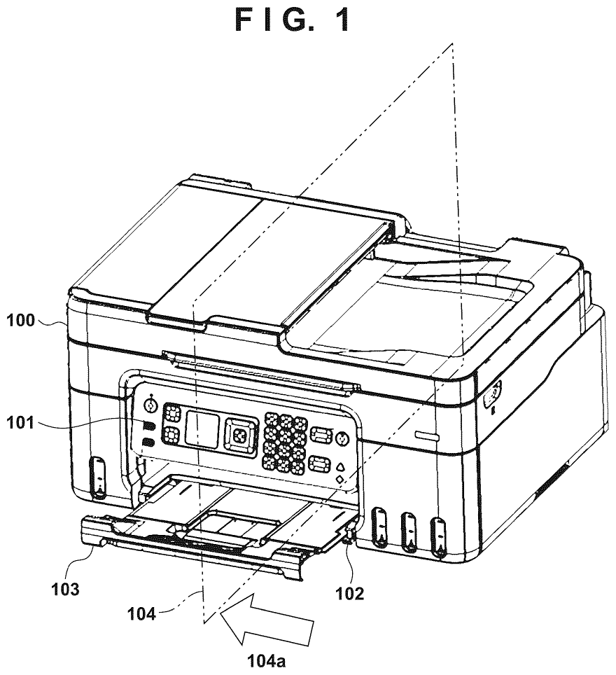

FIG. 1 is a perspective view showing the outer appearance of a printing apparatus 100 according to an embodiment. Assume that the printing apparatus 100 is an inkjet printer that can implement desired printing by discharging ink onto a sheet (which is typically a paper material but may be another sheet-like print medium). Although described in detail later, in the printing apparatus 100, sheets are fed one by one from a feed unit by a feed roller, conveyed to a print unit by a conveyance roller, and then undergo printing by the print unit. “Print” here means forming an image on a sheet, and the concept of images can typically include characters, numbers, symbols, graphic patterns, patterns, photos, and the like.

Note that the printing apparatus 100 may be a color printer, but may be a monochrome printer. The printing apparatus 100 may auxiliary have a printing function. For example, the printing apparatus 100 may be a Multi Function Peripheral (MFP) further having a scan function, a copy function, a FAX function, and the like.

As shown in FIG. 1, the printing apparatus 100 can include an operation panel 101, a cassette 102, and a discharge tray 103. The operation panel 101 is arranged on the front face of the printing apparatus 100, and can include user interfaces such as buttons and a touch panel. The discharge tray 103 is arranged below the operation panel 101. When the discharge tray 103 is pulled from the apparatus main body to the front face side, a printed sheet can be placed on the discharge tray 103. The cassette 102 is arranged below the discharge tray 103, and can function as a supply port for supplying unprinted sheets.

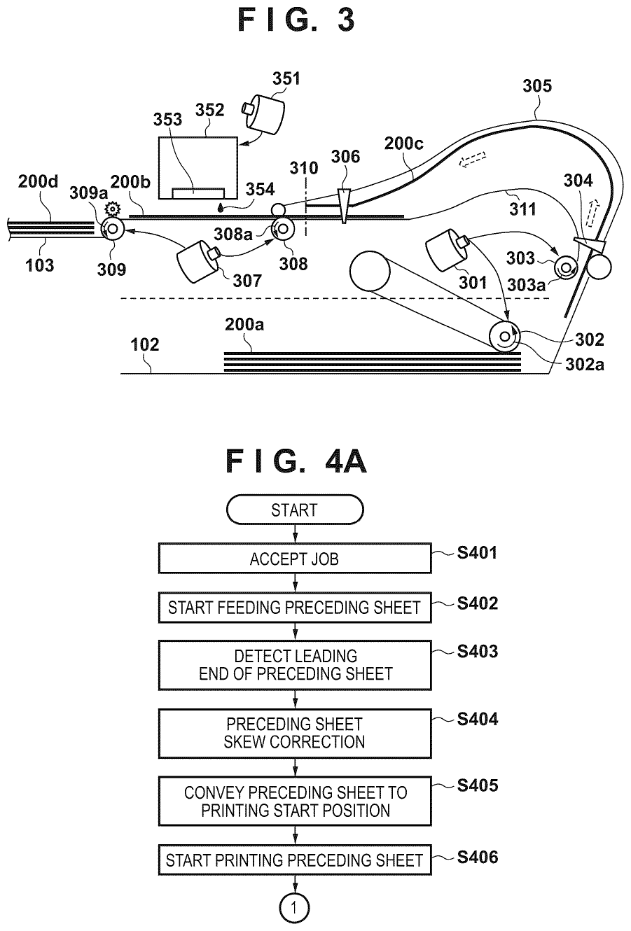

FIG. 3 is a schematic sectional view of the printing apparatus 100 (see FIG. 1) when viewed in a direction of an arrow 104a with respect to a section 104. The printing apparatus 100 further includes a feed unit 300 and a print unit 350.

The feed unit 300 includes a feed motor 301 and rollers 302 and 303. The roller 302 is a pickup roller that rotates in a direction 302a by being driven by the feed motor 301, and starts a sheet feed operation by picking up sheets 200a one by one from the cassette 102. The roller 303 is a feed roller that rotates in a direction 303a by being driven by the feed motor 301, and feeds a sheet 200c picked up by the pickup roller 302 toward a sheet feed path.

The feed unit 300 further includes a conveyance motor 307 and rollers 308 and 309. The roller 308 is a conveyance roller that rotates in a direction 308a by being driven by the conveyance motor 307, and conveys a sheet 200b fed along the sheet feed path toward the print unit 350. The roller 309 is a discharge roller that rotates in a direction 309a by being driven by the conveyance motor 307, and discharges a sheet 200d having undergone printing by the print unit 350 onto the discharge tray 103.

A detection sensor 304 is arranged on the upstream side of the sheet feed path, and a detection sensor 306 is arranged on the downstream side of the sheet feed path. This downstream side indicates the downstream side in the same direction as the sheet conveyance direction, and the upstream side indicates the opposite side thereof. Each of the detection sensors 304 and 306 can detect presence/absence of a sheet, and detects, for example, passage of the leading end (downstream-side end or downstream end) and trailing end (upstream-side end or upstream end) of a sheet. The detection sensors 304 and 306 may be expressed as print sheet end detection sensors.

Although described in detail later, while printing by the print unit 350 is executed on the preceding sheet 200b, the succeeding sheet 200c is fed to a waiting position 310, and the trailing end portion of the preceding sheet 200b and the leading end portion of the succeeding sheet 200c are overlapped. Such conveyance control is performed based on the detection results of the sensors 304 and 306. This conveyance mode can also be referred to as overlapping feeding, successive overlapped conveyance, or the like. The detection sensors 304 and 306 may be a part of the feed unit 300.

The print unit 350 includes a carriage motor 351 and a carriage 352. The carriage 352 is made to reciprocate in a direction intersecting (substantially orthogonal to) the sheet conveyance direction by receiving power from the carriage motor 351, and this can cause the printhead mounted on the carriage 352 to scan. The printhead is provided with a nozzle 353. With this configuration, ink droplets 354 are discharged from the nozzle 353 during scanning by the carriage 352 to perform printing on a sheet. Such the printhead can be expressed as a serial head or the like.

Although described in detail later, the printing apparatus 100 can handle a plurality of kinds of sheets, and execute a printing operation by selecting one from some sheet kinds as a print target. FIG. 3 shows the single cassette 102, but a user can place an arbitrary kind of sheet in the cassette 102. Alternatively, the printing apparatus 100 may be provided with a plurality of cassettes 102 on which a plurality of kinds of sheets can be placed, respectively.

In this structure, the print unit 350 is located above the cassette 102, which is advantageous in downsizing. In such the arrangement, the sheet feed path can be formed in a curved shape so that a sheet is provided from the cassette 102 to the print unit 350 located above. The sheet feed path includes a gap of a predetermined width so as to allow any of various kinds of sheets to smoothly pass therethrough. Thus, the sheet feed path can have an outer periphery 305 and an inner periphery 311.

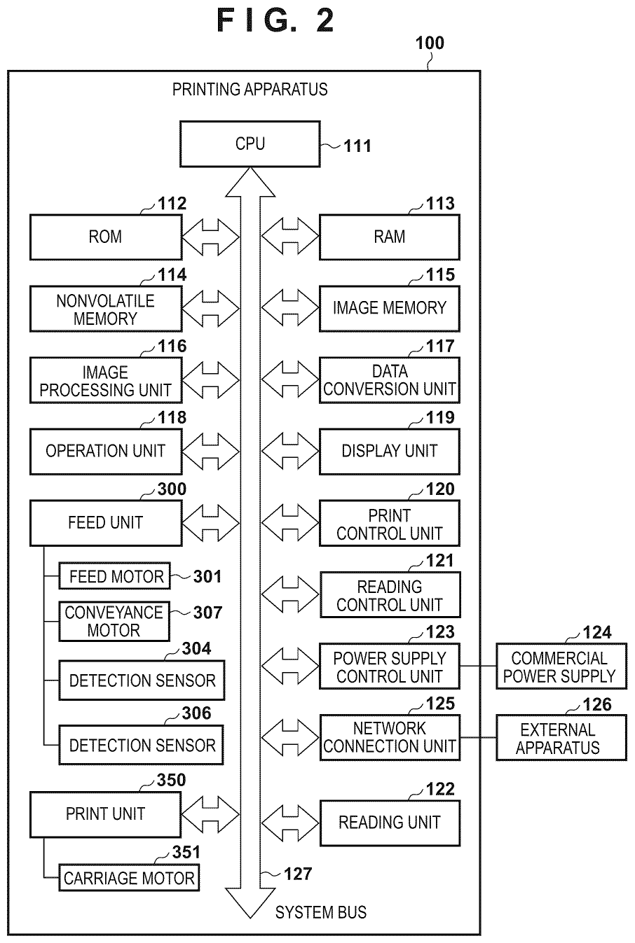

FIG. 2 is a block diagram showing an example of the system configuration of the printing apparatus 100. The printing apparatus 100 further includes a Central Processing Unit (CPU) 111, a Read Only Memory (ROM) 112, a Random Access Memory (RAM) 113, a nonvolatile memory 114, and an image memory 115. The printing apparatus 100 further includes an image processing unit 116, a data conversion unit 117, an operation unit 118, a display unit 119, a print control unit 120, a reading control unit 121, a reading unit 122, a power supply control unit 123, and a network connection unit 125.

The CPU 111 mainly functions as a system control unit (or simply a control unit) that controls driving of the entire printing apparatus 100.

The ROM 112 stores programs necessary for implementing the printing function, such as a control program executable by the CPU 111 and an embedded operating system (OS) program. For example, the CPU 111 executes the control program under the control of the embedded OS, thereby performing software control such as scheduling and task switching.

A Static RAM (SRAM) or the like is typically used for the RAM 113. The RAM 113 stores a setting value or parameter necessary for implementing the printing function, or management data of the printing apparatus 100.

A flash memory or the like is typically used for the nonvolatile memory 114. The nonvolatile memory 114 can hold necessary information even in a power-off state in which no power supply voltage is supplied. The nonvolatile memory 114 stores user data including network information, a list showing a connection history (an external apparatus 126 or the like), menu items such as a print mode, setting information including printhead correction information, and the like. For example, information indicating criteria used for arithmetic processing such as determination or a reference table in which the criteria are aggregated can be stored in the nonvolatile memory 114.

A Dynamic RAM (DRAM) or the like is typically used for the image memory 115. The image memory 115 holds image data. For example, the image memory 115 can hold image data externally received via the network connection unit 125, image data obtained by scan processing, image data processed by the image processing unit 116 to be described later, and the like.

The memory configuration in the printing apparatus 100 is not limited to the above example. The number, characteristics, sizes, or the like of the memories may be changed in accordance with the usage, purpose, or the like. That is, some of the functions of the respective elements 112 to 115 described above may be implemented by another element. Alternatively, some of the elements 112 to 115 described above may be combined into a single element. As an example, the function of the image memory 115, which can be formed by a DRAM or the like, may be implemented by the RAM 113. As another example, the image memory 115 may be formed by a Hard Disk Drive (HDD). Alternatively, the function of the image memory 115 may be implemented by the nonvolatile memory 114.

The image processing unit 116 performs image processing such as encoding/decoding processing or scaling processing on, for example, externally obtained image data (RGB data).

The data conversion unit 117 analyzes the page description language or the like to convert image data into print data. For example, the data conversion unit 117 performs smoothing processing, correction processing for the print density and color, and the like on externally obtained image data. The print data thus obtained is output to the print unit 350, and printing based on the print data is executed.

The operation unit 118 accepts an operation input from the user such as a button operation or panel operation. A liquid crystal display or the like is typically used for the display unit 119, and the display unit 119 can present necessary information to the user. Note that the operation unit 118 and the display unit 119 may be formed by a signal unit such as, for example, a touch panel display, and may be included in the operation panel 101.

The print control unit 120 can implement the printing function of the printing apparatus 100 by controlling driving of each of the feed unit 300 and the print unit 350. The print unit 350 executes printing on a sheet based on the print data output from the data conversion unit 117 and the setting information of the print job received from the external apparatus 126. When executing printing, the print control unit 120 updates the state information such as the ink residual amount of the ink tank and the state of the printhead. Note that the ink tank is assumed to be attached to the carriage 352, but it may be configured such that ink is supplied to the carriage 352 via a tube from an ink tank attached to the apparatus main body.

The reading control unit 121 can control driving of the reading unit 122 based on a job received by the printing apparatus 100, thereby acquiring image data from a document (a sheet with an image formed thereon). The reading control unit 121 can output the acquired image data to the image processing unit 116 or the data conversion unit 117. Image data such as the acquired image data and intermediate data processed by the image processing unit 116 or the data conversion unit 117 can be held by the image memory 115 (or an external storage device (not shown)).

A known optical sensor such as a Charge Coupled Devices (CCD) sensor or a Contact Image Sensor (CIS) may be used for the reading unit 122. An Auto Document Feeder (ADF) which automatically conveys a plurality of documents and executes image reading may be used for the reading unit 122.

The power supply control unit 123 controls a connection with a commercial power supply system 124 serving as a commercial power supply source, thereby implementing power supply to the printing apparatus 100.

The network connection unit 125 enables the printing apparatus 100 to communicate with the external apparatus 126 by a predetermined communication means. Thus, the printing apparatus 100 can receive a job from, for example, the external apparatus 126. Wi-Fi® or the like can be typically used as the communication method of the network connection unit 125.

Jobs received by the printing apparatus 100 include, in addition to a job received from the external apparatus 126, a job input via the operation unit 118. The external apparatus 126 may be a general-purpose computer such as a laptop computer or a notebook computer, but may be a mobile terminal such as a smartphone or a tablet, or an electronic apparatus such as a digital camera. Examples of the job include, in addition to a print job for causing the printing apparatus 100 to execute printing, a scan job for acquiring image data from a document by scanning, and a copy job for causing the printing apparatus 100 to execute duplication. The print job can include, in addition to image data indicating the image to be formed on a sheet, setting information necessary for implementing desired printing such as the number of sheets to be used for the printing, the sheet kind, the quality of printing, and the speed of printing. The image data included in the print job is converted into print data by the data conversion unit 117 and output to the print unit 350.

The elements 111 to 123, 125, 300, and 350 described above are interconnected via a system bus 127 managed by the CPU 111, and a signal, data, or information can be exchanged between the elements.

Referring to FIG. 3 again, the feed motor 301 serving as one of driving sources of the feed mechanism for feeding sheets is connected to the roller 302 and the roller 303 via a drive transmission mechanism (not shown) including gears and belts. When the feed motor 301 rotates forward, the roller 302 and the roller 303 are rotated in the directions 302a and 303a, respectively, thereby feeding a sheet to the sheet feed path. The feed motor 301 is provided with an encoder (not shown), and the CPU 111 can detect the conveyance amount of the sheet. After passing through the detection sensor 304, the fed sheet is conveyed along the sheet feed path outer periphery 305 toward the detection sensor 306.

The detection sensors 304 and 306 detect the leading end and trailing end of the sheet fed as described above. At the timing when the detection sensor 304 detects the leading end of the sheet, the CPU 111 receives a signal from the encoder and holds the encoder information in the RAM 113. Based on the conveyance amount of the sheet by the feed motor 301 from this timing, the CPU 111 can control the position of the leading end of the fed sheet. In addition, at the timing when the detection sensor 304 detects the trailing end of the sheet, the CPU 111 holds the encoder information in the RAM 113. Based on these pieces of encoder information, the CPU 111 can calculate the length (sheet length) of the fed sheet.

Note that, although described in detail later, in this specification, for the sake of convenience, the position detected by the detection sensor 304 is described as the first position information, and the position detected by the detection sensor 306 is described as the second position information. For example, the position of the leading end of the sheet detected by the detection sensor 304 is referred to as the first leading end position information, and the position of the leading end of the sheet detected by the detection sensor 306 is referred to as the second leading end position information.

In this manner, the CPU 111 can control the print position of the sheet, and control the relative positional relationship between the preceding sheet 200b and the succeeding sheet 200c. In this embodiment, a mechanism formed by a combination of a sensor dog and a photomicrosensor detects the leading end and trailing end of a sheet. Alternatively/additionally, a transmissive fiber sensor, a reflective laser sensor, or the like may be used.

The conveyance motor 307 serving as one of driving sources of the conveyance mechanism for conveying sheets is connected to the rollers 308 and 309 via a drive transmission mechanism (not shown) including gears. When the conveyance motor 307 rotates forward, the roller 308 and the roller 309 are rotated in the directions 308a and 309a, respectively, thereby conveying the sheet toward the print unit 350 and discharging the sheet onto the discharge tray 103. The conveyance motor 307 is provided with another encoder, and the CPU 111 can detect the conveyance amount of the sheet. The printed sheet 200d discharged as described above can be stacked on the discharge tray 103.

In the print unit 350, the nozzle 353 includes a plurality of ink discharge ports arrayed in the sheet conveyance direction and the sheet width direction, and the nozzle 353 is scanned in the sheet width direction. The CPU 111 controls driving of each of the conveyance motor 307 and the carriage motor 351, thereby alternately performing a conveyance operation of intermittently conveying a sheet by a unit conveyance amount, and a discharge operation of discharging ink while scanning with respect to the sheet between the conveyance operations.

Note that, since the discharge roller 309 comes into contact with the sheet immediately after printing, it is possible to reduce the contact area and prevent ink transfer by adopting, for example, a gear shape so as to make point contact with the sheet.

As has been described above, in this embodiment, overlapped feeding is performed in which, while printing on the preceding sheet 200b is performed, the succeeding sheet 200c is fed to the waiting position 310, thereby overlapping the trailing end portion of the preceding sheet 200b and the leading end portion of the succeeding sheet 200c. With this, successive printing on the sheets 200b and 200c (or two or more sheets 200) can be implemented.

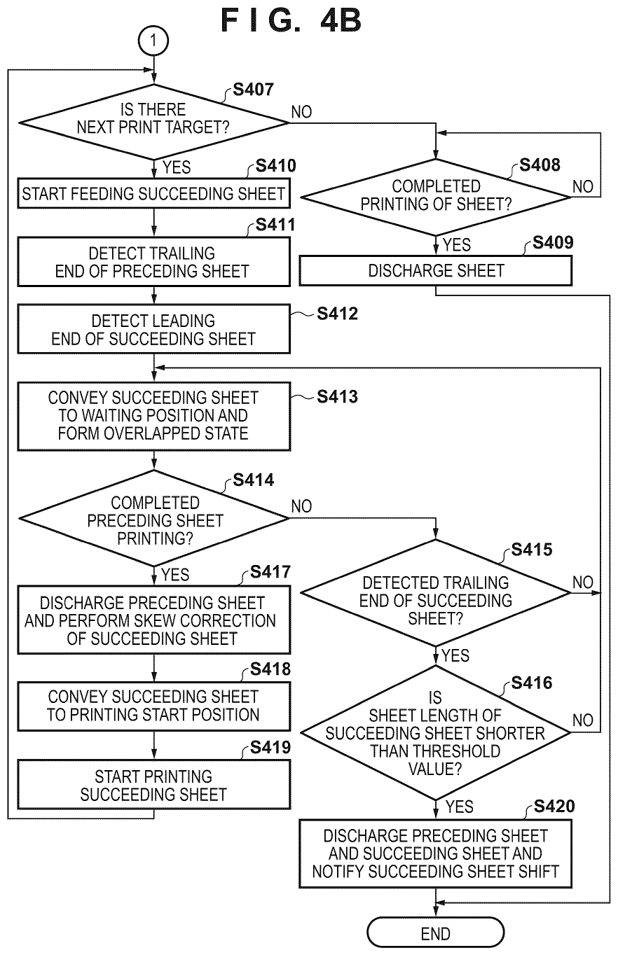

FIGS. 4A and 4B are a flowchart showing an example of control contents for executing a printing operation accompanying overlapped feeding. In this example, consider a case of performing overlapped feeding of the sheets 200b and 200c. Each step exemplified here can be implemented by the CPU 111 reading out the program stored in the ROM 112 or the like into the RAM 113 and executing it. This also applies to the other flowcharts to be described later.

In step S401 (to be simply referred to as “S401” hereinafter; the same applies to the other steps to be described later), the CPU 111 accepts a job. As has been described above, for example, the job is input via the operation unit 118 or input from the external apparatus 126 via the network connection unit 125.

In S402, based on the setting information of the accepted job, the CPU 111 first starts a feed operation of feeding the sheet 200b.

In S403, the CPU 111 detects the position of the leading end of the preceding sheet 200b by the detection sensor 304, and holds the result as the first leading end position information of the preceding sheet 200b in the RAM 113. The CPU 111 further performs the feed operation, detects the position of the leading end of the preceding sheet 200b by the detection sensor 306, and holds the result as the second leading end position information of the preceding sheet 200b in the RAM 113.

In S404, based on the second leading end position information of the preceding sheet 200b which is the detection result of the detection sensor 306, the CPU 111 feeds the preceding sheet 200b to the waiting position 310. Thereafter, the CPU 111 causes the leading end portion of the preceding sheet 200b to abut against the conveyance roller 308, thereby performing skew correction of correcting the skew of the preceding sheet 200b. The waiting position 310 may be expressed as a skew correction waiting position.

In S405, the CPU 111 causes the conveyance roller 308 to rotate forward to convey the preceding sheet 200b to the printing start position below the nozzle 353.

In S406, the CPU 111 starts printing on the preceding sheet 200b by the print unit 350 based on the setting information included in the job and the print data described above. As has been described above, the printing operation is performed by alternately performing a conveyance operation of intermittently conveying the sheet 200b by a unit conveyance amount and a discharge operation of discharging ink while scanning with respect to the sheet 200b between the printing operations. Note that, in the conveyance operation, the sheet 200b is intermittently conveyed, and the conveyance amount per one conveyance corresponds to the length of the nozzle 353 in the conveyance direction (nozzle length).

In S407, the CPU 111 determines presence/absence of the next print target (print data to be printed on a sheet as the next page) in the job accepted in S401. If there is no next print target (if the succeeding sheet 200c does not occur), the process advances to S408; otherwise (if the succeeding sheet 200c occurs), the process advances to S410.

In S408, the CPU 111 alternately repeats the conveyance operation and the discharge operation for the preceding sheet 200b until the printing on the preceding sheet 200b is completed. If the printing on the preceding sheet 200b is completed, the process advances to S409.

In S409, the CPU 111 causes the rollers 308 and 309 to rotate forward to perform a discharge operation of discharging the printed preceding sheet 200b onto the discharge tray 103. Thus, this flowchart ends.

In S410, the CPU 111 starts a feed operation of picking up the next sheet 200 from the cassette 102 and feeding it as the succeeding sheet 200c.

In S411, the CPU 111 conveys the preceding sheet 200b by the conveyance roller 308, detects the position of the trailing end of the preceding sheet 200b by the detection sensor 304, and holds the result as the first trailing end position information in the RAM 113. The CPU 111 can calculate the length of the preceding sheet 200b based on the first leading end position information of the preceding sheet 200b acquired in S403 and the first trailing end position information of the preceding sheet 200b acquired in this step.

In S412, the CPU 111 detects the position of the leading end of the succeeding sheet 200c by the detection sensor 304, and holds the result as the first leading end position information in the RAM 113.

In S413, the CPU 111 calculates the trailing end position of the preceding sheet 200b based on the first trailing end position information of the preceding sheet 200b acquired in S411 and the conveyance amount of the preceding sheet 200b by the conveyance operation in the printing operation performed thereafter. Further, the CPU 111 controls driving of the feed roller 304 based on the first leading end position information of the succeeding sheet 200c acquired in S412 so as to prevent interference between the trailing end of the preceding sheet 200b and the leading end of the succeeding sheet 200c. The CPU 111 performs the feed operation such that the leading end of the succeeding sheet 200c reaches the waiting position 310. In this manner, the overlapping state of the trailing end portion of the preceding sheet 200b and the leading end portion of the succeeding sheet 200c is set.

In S414, the CPU 111 determines whether the printing on the preceding sheet 200b is completed. If the printing on the preceding sheet 200b is completed, the process advances to S417; otherwise, the process advances to S415.

In S415, the CPU 111 determines whether the detection sensor 304 detects the trailing end of the succeeding sheet 200c. If the trailing end of the succeeding sheet 200c is detected, the process advances to S416; otherwise, the process returns to S413. With this, the succeeding sheet 200c is fed to the waiting position 310 during the printing operation of the preceding sheet 200b.

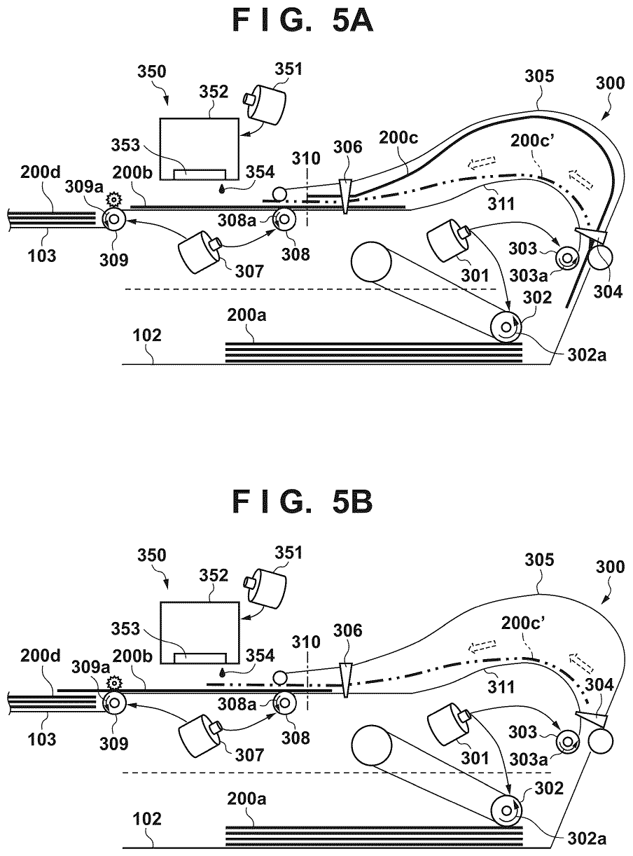

In S416, although described in detail later (see FIGS. 5A and 5B), it is determined whether the length of the succeeding sheet 200c is shorter than a threshold value (to be described later). If the length of the succeeding sheet 200c is shorter than the threshold value, the process advances to S420; otherwise, the process returns to S413 and the printing operation of the preceding sheet 200b is continued.

In S417, the CPU 111 discharges the preceding sheet 200b onto the discharge tray 103 by the discharge roller 309, and corrects the skew of the succeeding sheet 200c by causing the leading end portion of the succeeding sheet 200c waiting at the waiting position 310 to abut against the conveyance roller 308. At this time, in order to cause the leading end portion of the succeeding sheet 200c to abut against the conveyance roller 308, the conveyance roller 308 is in a stop state. In this embodiment, both the rollers 308 and 309 are driven by the conveyance motor 307. Therefore, at the timing of skew correction of the succeeding sheet 200c, discharge of the preceding sheet 200b is temporarily interrupted.

In S418, the CPU 111 causes the conveyance roller 308 to rotate forward to convey the succeeding sheet 200c to the printing start position below the nozzle 353.

In S419, the CPU 111 starts printing on the succeeding sheet 200c by the print unit 350 based on the setting information included in the job and the print data described above. Thereafter, the process returns to S407 to determine presence/absence of the further next print target. Similar processing is repeated for all sheets. Note that, if the process returns to S407, steps after S407 are preformed while setting the succeeding sheet 200c as the new preceding sheet and setting the next sheet of the succeeding sheet 200c as the new succeeding sheet.

In S420, although described in detail later, the CPU 111 performs predetermined processing assuming that a succeeding sheet shift has occurred.

In overlapped feeding, depending on the internal structure of the apparatus 100 such as the sheet feed path and the characteristics (mainly rigidity) of the succeeding sheet 200c, an unexpected conveyance mode may occur. For example, if the rigidity is high, the succeeding sheet 200c is hard to bend/warp in the sheet feed path, but if the rigidity is low, the succeeding sheet 200c easily bends/warps in the sheet feed path.

FIGS. 5A and 5B are schematic views for explaining an example of the conveyance mode of the succeeding sheet 200c.

FIG. 5A shows a state in which the leading end of the sheet 200c is fed to the waiting position 310 in S413 described above. Depending on the kind of the sheet 200c (for example, if the rigidity is low), the sheet 200c may be conveyed not along the sheet feed path outer periphery 305 but along the sheet feed path inner periphery 311, that is, may be fed in the shape exemplified by a sheet 200c′. In this case, the leading end of the sheet 200c′ can pass through the waiting position 310 and reach the conveyance roller 308.

FIG. 5B shows a state in which the leading end of the sheet 200c′ has reached the conveyance roller 308 and the printing operation of the preceding sheet 200b is continued in FIG. 5A.

Here, in order to improve the accuracy of the printing operation of the sheet 200b, the sheet holding (nipping) force of the conveyance roller 308 can be set to be largest among the rollers 302, 303, 308, and 309 exemplified in this embodiment. Accordingly, for example, even if the feed roller 303 is in a stop state, if the conveyance roller 308 rotates forward for the printing operation of the sheet 200b, the sheet 200c′ is conveyed to below the nozzle 353. That is, since the sheet 200 is generally conveyed not along the outer periphery 305 but along the inner periphery 311 depending on its rigidity, if the sheet 200 is conveyed along the inner periphery 311 like the sheet 200c′, the sheet 200 may reach the conveyance roller 308 whose holding force is strong. In this case, the sheet 200c′ is unexpectedly conveyed to below the nozzle 353 and the trailing end of the sheet 200c′ is detected by the detection sensor 304. As a result, due to the determination in S415 described above, the process advances to S416.

In this embodiment, in S415, the CPU 111 detects the position of the trailing end of the succeeding sheet 200c by the detection sensor 304, and holds the result as the first trailing end position information in the RAM 113. Then, the CPU 111 calculates the length of the succeeding sheet 200c based on the first leading end position information of the succeeding sheet 200c acquired in S412 and the first trailing end position information of the succeeding sheet 200c acquired in S415.

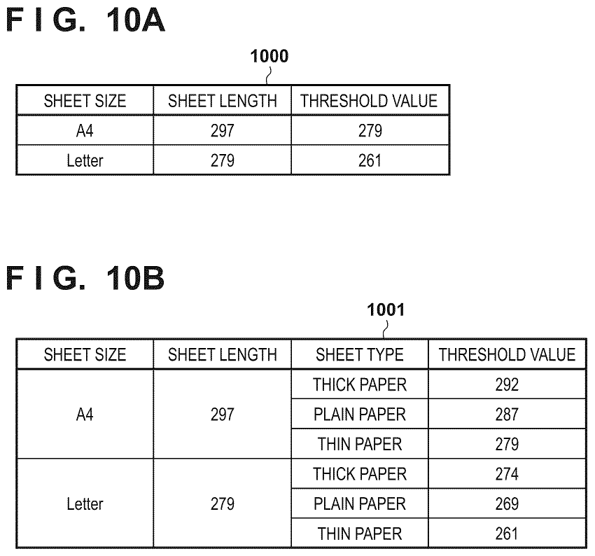

The CPU 111 compares the length of the succeeding sheet 200c calculated in this manner with a threshold value (to be described later). If the length of the succeeding sheet 200c is shorter than the threshold value, the process advances to S420. The threshold value used here can be set to a value obtained by subtracting, from the sheet length indicated by the sheet length information included in the job, a fixed value based on the path difference between the outer periphery 305 and the inner periphery 311 (see FIGS. 10A and 10B).

FIG. 10A is a table 1000 showing examples of threshold values. Here, as an example, a value obtained by subtracting 18 mm from the sheet length of each sheet size (for example, A4 size, Letter size, or the like) is set as the threshold value. The threshold value is used as a reference value for determining the shift of the succeeding sheet 200c.

During sheet feeding, whether the sheet is conveyed along the sheet feed path outer periphery 305 like the sheet 200c or conveyed along the sheet feed path inner periphery 311 like the sheet 200c′ can change depending on the sheet type (for example, plain paper, thick paper, thin paper, or the like; in the following description, sheet size and sheet type will be collectively referred to as sheet kind). In this case, the threshold value is preferably set in consideration of the sheet kind/for each sheet kind.

FIG. 10B is a table 1001 showing an example of a threshold value for each sheet kind. For example, if a sheet is thin (if the rigidity is low), the sheet tends to be conveyed along the sheet feed path inner periphery 311 like the sheet 200c′, so that the threshold value can be set relatively small.

The threshold values described above are held as fixed values in the ROM 112 and referred to when the CPU 111 executes a job. Note that the threshold value may be set based on an operation input via the operation panel 101. In that case, an appropriate value may be set based on the sheet kind used by the user. Alternatively, the threshold values described above may be included in the job from the external apparatus 126, and may be deployed in the RAM 113 and referred to by the CPU 111 when executing the job.

Like the sheet 200c′ shown in FIG. 5B, if the succeeding sheet is conveyed along the inner periphery 311 and reaches the conveyance roller 308 whose holding force is strong, the succeeding sheet 200c′ reaches below the nozzle 353 during the printing operation of the preceding sheet 200b. If such the shift (to be referred to as the succeeding sheet shift hereinafter) of the succeeding sheet 200c occurs, the printing operation of the preceding sheet 200b is not properly performed.

Therefore, in S420 of FIG. 4B, the CPU 111 interrupts the printing operation of the preceding sheet 200b, and causes the rollers 303, 308, and 309 to rotate forward to discharge the preceding sheet 200b and the succeeding sheet 200c′ onto the discharge tray 103. Thereafter, the CPU 111 notifies the user of occurrence of the succeeding sheet shift, and terminates the flowchart of FIGS. 4A and 4B. This notification is made by, for example, displaying a notification screen 900 shown in FIG. 9A on the display unit 119. Alternatively/additionally, the notification screen 900 may be displayed on the display unit of the external apparatus 126.

In the example described above, the mode of discharging the preceding sheet 200b and the succeeding sheet 200c′ in S420 has been described. However, depending on the internal structure of the printing apparatus 100 such as the shape of the sheet feed path or the like, a sheet may bend in the apparatus 100. In such a case, without discharging the sheets 200b and 200c′ in S420, the user may be notified that the sheets should be manually removed. In this case, as shown in FIG. 9B, a notification screen 901 prompting manual removal of the sheets 200b and 200c′ is preferably displayed.

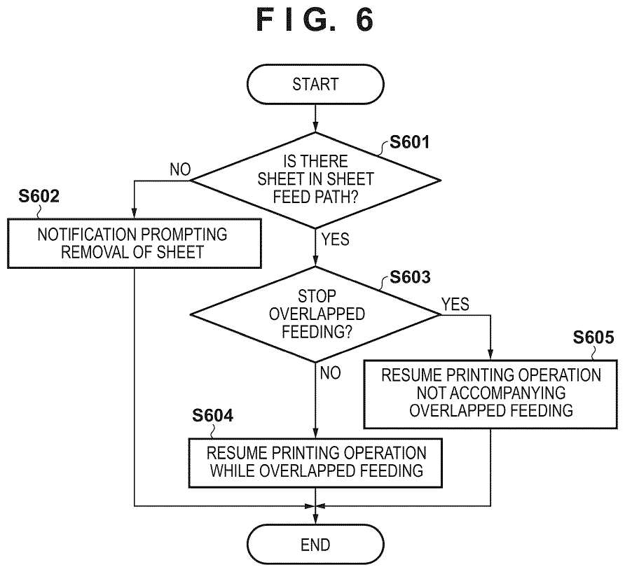

FIG. 6 is a flowchart illustrating a recovery operation performed after a succeeding sheet shift occurs. This flowchart can be executed when a predetermined operation input is performed by the user in S420 of FIG. 4B. As an example, this flowchart is executed when a printing operation resume instruction to the printing apparatus 100, such as a confirmation button or an OK button, is pressed in the notification screen 900 or 901.

In S601, the CPU 111 determines presence/absence of a sheet in the sheet feed path based on the detection results of the detection sensors 304 and 306. If a sheet exists, the process advances to S602. If no sheet exists, the process advances to S603.

In S602, the CPU 111 continues the notification prompting removal of the sheet remaining in the sheet feed path, and terminates this flowchart. That is, until the user performs an operation input again, the notification screen 900 or 901 (or a similar notification screen) remains displayed, and a waiting state is set.

In S603, although described in detail later, the CPU 111 determines whether to stop overlapped feeding in the printing operation performed after the succeeding sheet shift occurs. If overlapped feeding is stopped, the process advances to S605; otherwise (if overlapped feeding is performed), the process advances to S604.

In S604, while performing overlapped feeding, the CPU 111 resumes the printing operation based on the flowchart of FIGS. 4A and 4B.

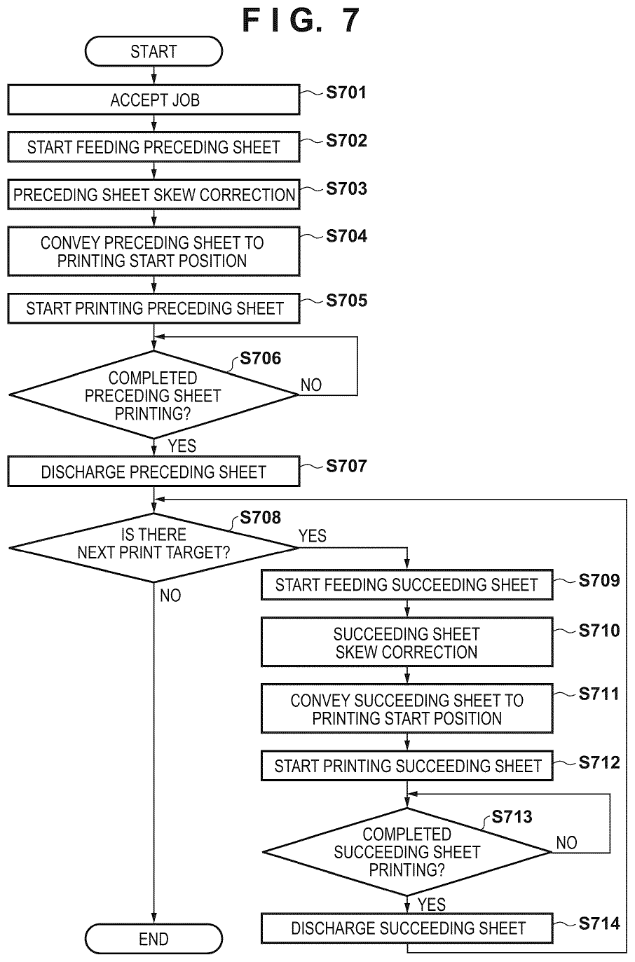

In S605, the CPU 111 resumes the printing operation not accompanying overlapped feeding (see FIG. 7).

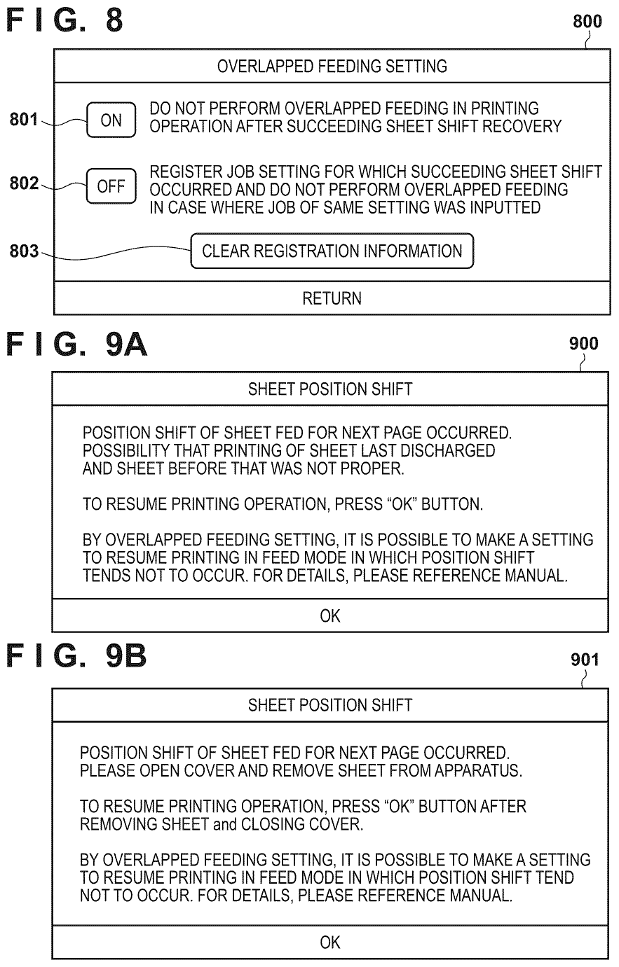

FIG. 8 shows a setting screen 800 regarding overlapped feeding. When the setting screen 800 is displayed on the operation panel 101, the user can make predetermined setting. The setting information about this setting is held in the nonvolatile memory 114, and referred to by the CPU 111 upon executing the job. Alternatively/additionally, the setting screen 800 may be displayed on the display unit of the external apparatus 126, and the above-described setting information may be held in the RAM 113 as a part of the job transmitted from the external apparatus 126 to the printing apparatus 100 and referred to by the CPU 111 upon executing the job.

The setting screen 800 includes settings 801 and 802. By turning on the setting 801, the user can set to stop overlapped feeding in the printing operation performed after the recovery operation is executed with respect to the succeeding sheet shift. Further, by turning on the setting 802, the user can register (or store) the job setting in occurrence of the succeeding sheet shift, and set to stop overlapped feeding if the same setting is input.

For example, if the setting 801 is ON, the CPU 111 determines in S603 to stop overlapped feeding in the printing operation performed after the succeeding sheet shift occurs, and advances to S605.

If the setting 802 is ON, when a succeeding sheet shift occurs, the job setting at that time is registered. Thereafter, when a job having the same setting is input, a printing operation not accompanying overlapped feeding is performed. Note that the job setting may be registered in S420 of FIG. 4B.

The setting screen 800 further includes a clear button 803, and the user can use the clear button 803 to delete the contents (the job setting in occurrence of the succeeding sheet shift) registered by the setting 802.

As another embodiment, if the capacity of the RAM 113 is relatively small, print data held in the RAM 113 can be sequentially deleted as the printing operation progresses. In this case, when resuming the printing operation of the preceding sheet 200b, the print data of the preceding sheet 200b may not remain so that the printing operation can be performed from the print data of the succeeding sheet 200c/200c′ while skipping printing of the preceding sheet 200b. In addition, if the unexpected conveyance mode like the succeeding sheet 200c′ occurs, the printing operation of the preceding sheet 200b may not have been properly completed. Therefore, the timing of deleting the print data of the preceding sheet 200b is preferably delayed based on the capacity of the RAM 113 and within a feasible range until the printing operation of the preceding sheet 200b is properly completed. With this, the printing operation of the preceding sheet 200b can be properly resumed, and the printing operation of remaining sheets can also be properly performed. Thus, the user can properly acquire all printed products.

FIG. 7 is a flowchart for performing a printing operation not accompanying overlapped feeding. For the sake of descriptive convenience, the contents of S701 to S705 are partially omitted, but they are similar to the contents of S401 to S406 (see FIG. 4A). That is, in S701, the CPU 111 accepts a job. In S702, based on the setting information of the accepted job, the CPU 111 starts a feed operation of feeding the sheet 200b. In S703, the CPU 111 corrects the skew of the preceding sheet 200b by causing the leading end portion of the preceding sheet 200b to abut against the conveyance roller 308. In S704, the CPU 111 causes the conveyance roller 308 to rotate forward to convey the preceding sheet 200b to the printing start position below the nozzle 353. In S705, the CPU 111 starts printing on the preceding sheet 200b by the print unit 350 based on the setting information included in the job and the print data described above.

In S706, the CPU 111 determines whether the printing on the preceding sheet 200b is completed. If the printing on the preceding sheet 200b is completed, the process advances to S707; otherwise, the process returns to S706. That is, the printing is continued until the printing on the preceding sheet 200b is completed. When the printing is completed, the process advances to S707.

In S707, the CPU 111 causes the rollers 308 and 309 to rotate forward, thereby discharging the printed preceding sheet 200b onto the discharge tray 103.

In S708, the CPU 111 determines presence/absence of the next print target (print data to be printed on a sheet as the next page) in the job accepted in S701. If there is no next print target (if the succeeding sheet 200c does not occur), this flowchart is terminated; otherwise (if the succeeding sheet 200c occurs), the process advances to S709.

In S709 to S712, control similar to that in S702 to S705 is performed for the succeeding sheet 200c. That is, in S709, based on the setting information of the accepted job, the CPU 111 starts a feed operation of feeding the sheet 200c. In S710, the CPU 111 causes the leading end portion of the sheet 200c to abut against the conveyance roller 308, thereby correcting the skew of the sheet 200c. In S711, the CPU 111 causes the conveyance roller 308 to rotate forward to convey the sheet 200c to the printing start position below the nozzle 353. In S712, the CPU 111 starts printing on the sheet 200c by the print unit 350 based on the setting information included in the job and the print data described above.

In S713, as in S706, the CPU 111 determines whether the printing on the succeeding sheet 200c is completed. If the printing on the succeeding sheet 200c is completed, the process advances to S714; otherwise, the process returns to S713.

In S714, as in S707, the CPU 111 causes the rollers 308 and 309 to rotate forward to discharge the printed succeeding sheet 200c onto the discharge tray 103, and returns to S708. In this manner, presence/absence of the further next print target is determined, and similar processing is repeated for all sheets.

According to this flowchart, it is possible to perform proper feeding, conveyance, and printing of each sheet, so that unexpected incidents such as conveyance of the succeeding sheet 200c′ to below the nozzle 353 as exemplarily shown in FIG. 5B can be prevented.

### BRIEF SUMMARY

As has been described above, when executing overlapped feeding, as described with reference to FIG. 5A, the succeeding sheet 200c can be conveyed to the waiting position 310 during the printing operation of the preceding sheet 200b. However, depending on the sheet kind, the succeeding sheet 200c is conveyed along the inner periphery 311 as indicated by the succeeding sheet 200c′. Hence, as described with reference to FIG. 5B, the succeeding sheet 200c′ may pass the waiting position 310 and reach the conveyance roller 308 whose holding force is strong. In this case, the succeeding sheet 200c′ reaches below the nozzle 353 during the printing operation of the preceding sheet 200b, and it becomes difficult to implement the proper printing operation of the preceding sheet 200b.

Therefore, in this embodiment, based on the setting information included in the job and using corresponding one of the threshold values exemplarily shown in FIGS. 10A and 10B, it is determined whether the length of the succeeding sheet 200c/200c′ meets the criteria. If the sheet length is shorter than the threshold value, it is considered that a succeeding sheet shift has occurred, and the notification screen 900/901 is output (see S420 of FIG. 4B). With this, the user can execute a recovery operation with respect to the succeeding sheet shift. In addition, based on the occurrence of the unexpected conveyance, the user can use the setting screen 800 to select whether to execute overlapped feeding. Furthermore, the user can register the setting in occurrence of the unexpected conveyance, thereby preventing reoccurrence of the unexpected conveyance.

According to this embodiment, when unexpected conveyance has occurred, which can occur in the conventional apparatus configuration, the user can properly deal with it, and properly acquire all printed products. This is advantageous in improving usability.

### <Program>

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The concept of a processor can include not only the CPU 111 exemplified in the embodiment but also a microprocessing unit (MPU), a Graphics Processing Unit (GPU), a Field Programmable Gate Array (FPGA), and the like. The concept of a memory used by a processor to execute a program can include not only the RAM, ROM, HDD, and the like exemplified in the embodiment but also other known storage media or storage devices such as a solid state drive (SSD). Individual programs or functions exemplified in the embodiment may be implemented by a distributed computing system.

### <Others>

In the above description, the printing apparatus 100 using the inkjet printing method has been described as an example. However, the printing method is not limited to this. Furthermore, the printing apparatus 100 may be a single function printer having only a printing function or may be a multi-function printer having a plurality of functions such as a printing function, a FAX function, and a scanner function. In addition, the printing apparatus may be a manufacturing apparatus configured to manufacture, for example, a color filter, an electronic device, an optical device, a microstructure, or the like by a predetermined printing method.

Furthermore, “print” in this specification should be interpreted in a broader sense. Hence, the mode of “print” is irrespective of whether or not the target to be formed on a print medium is significant information such as a character or graphic pattern, and is also irrespective of whether the target is manifested in a way that can be perceived visually by humans.

“Print medium”, which is described as the sheet 200 in the embodiments, should also be interpreted in a broader sense, like “print”. Hence, the concept of “print medium” can include not only paper used in general but also any materials capable of receiving ink, including fabrics, plastic films, metals, glass, ceramics, resins, wood, and leathers.

Ink should also be interpreted in a broader sense, like “print”. Hence, the concept of “ink” can include not only a liquid that is applied to a print medium to form an image, a design, a pattern, or the like but also an incidental liquid that can be provided to process a print medium or process ink (for example, coagulate or insolubilize color materials in ink applied to a print medium).

In each of the embodiments, the name of each element is expressed based on the main function but the function described in the embodiment may be a sub-function. The present invention is not strictly limited to this. This expression can be replaced by a similar expression. In the same vein, an expression “unit (portion)” can be replaced with an expression “tool”, “component”, “member”, “structure”, “assembly”, or the like. Alternatively, these may be omitted or attached.

Two or more elements exemplified as selectable in the embodiment are not strictly limited to the example, and may be arbitrarily combined. For example, each of the two or more exemplified elements may be additionally or alternatively selected. As an example, when arbitrarily combining two elements A and B, to indicate either “only A”, “only B”, or “both A and B”, an expression “A and/or B” or “at least one of A and B” may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-120182, filed on Jul. 24, 2023, which is hereby incorporated by reference herein in its entirety.

What is claimed is:

1. A printing apparatus capable of performing printing on a plurality of kinds of sheets, comprising:
a print unit configured to perform printing on a sheet;
a feed unit configured to feed a sheet toward the print unit; and
a control unit configured to, in a case of successively performing printing on a plurality of sheets by the print unit, control the feed unit to perform overlapped feeding in which a succeeding sheet is fed such that a trailing end portion of a preceding sheet and a leading end portion of the succeeding sheet overlap,
wherein, in a case of executing the overlapped feeding, the control unit makes a predetermined notification based on a comparison result of a length of the succeeding sheet with a threshold value corresponding to a sheet kind of the succeeding sheet.

2. The apparatus according to claim 1, wherein
the sheet kind includes a plurality of sheet sizes and/or a plurality of sheet types, and
the threshold value is set for each sheet kind.

3. The apparatus according to claim 1, wherein
the control unit starts a printing operation by driving the print unit and the feed unit based on a job, and the job includes image data indicating an image to be printed on a sheet and setting information indicating a sheet kind of the sheet, and
the control unit compares the length of the succeeding sheet with the threshold value corresponding to the setting information.

4. The apparatus according to claim 3, further comprising a cassette in which the plurality of kinds of sheets can be set,
wherein the print unit is located above the cassette, and a sheet feed path from the cassette to the print unit is formed in a curved shape.

5. The apparatus according to claim 4, further comprising a detection sensor arranged in the sheet feed path and configured to be capable of detecting presence/absence of a sheet,
wherein the control unit acquires the length of the succeeding sheet based on a detection result of the detection sensor.

6. The apparatus according to claim 5, wherein
if the length of the succeeding sheet is shorter than the threshold value, the control unit interrupts the printing operation and, thereafter, in a case of resuming the printing operation, determines whether to perform the overlapped feeding.

7. The apparatus according to claim 6, wherein
in the case of resuming the printing operation, the control unit skips printing on the preceding sheet and performs printing on the succeeding sheet.

8. The apparatus according to claim 6, further comprising a memory,
wherein, if the length of the succeeding sheet is shorter than the threshold value, the control unit registers setting information of a job at that time in the memory.

9. The apparatus according to claim 4, wherein
the feed unit includes a feed roller configured to feed a sheet from the cassette to the sheet feed path, and a conveyance roller configured to convey the sheet from the sheet feed path to the print unit.

10. The apparatus according to claim 9, wherein
a sheet holding force of the conveyance roller is larger than a sheet holding force of the feed roller.

11. The apparatus according to claim 1, further comprising a discharge tray onto which a printed sheet is discharged,
wherein if the length of the succeeding sheet is shorter than the threshold value, the control unit makes the notification after discharging the preceding sheet and the succeeding sheet.

12. A computer-readable storage medium storing a program, the program configured to cause a computer to function as each unit of the printing apparatus according to claim 1.
